(19) United States
(12) Patent Application Publication
(10) Pub. No.: US 2013/0156362 A1
(43) Pub. Date: Jun. 20, 2013

(54) CORE AND OPTICAL WAVEGUIDE

(71) Applicants: Duk Jun KIM, Daejeon (KR); Jong-Hoi Kim, Daejeon (KR); Joong-Seon Choe, Daejeon (KR); Chun Ju Youn, Daejeon (KR); Kwang-Seong Choi, Daejeon (KR); Yong-Hwan Kwon, Daejeon (KR); Eun Soo Nam, Daejeon (KR)

(72) Inventors: Duk Jun KIM, Daejeon (KR); Jong-Hoi Kim, Daejeon (KR); Joong-Seon Choe, Daejeon (KR); Chun Ju Youn, Daejeon (KR); Kwang-Seong Choi, Daejeon (KR); Yong-Hwan Kwon, Daejeon (KR); Eun Soo Nam, Daejeon (KR)

(73) Assignee: ELECTRONICS AND TELECOMMUNICATIONS RESEARCH INSTITUTE, Daejeon (KR)

(21) Appl. No.: 13/611,085

(22) Filed: Sep. 12, 2012

(30) Foreign Application Priority Data
Dec. 14, 2011 (KR) 10-2011-0134353

(51) Int. Cl. G02B 6/26; G02B 6/00

(52) U.S. Cl. 385/11; 385/43

(57) ABSTRACT

Provided is a core which reduces optic splice loss between discontinuous optical waveguides. The core includes a first waveguide propagation portion having first light-receiving width, a first lightwave discontinuous portion having second light-receiving width, a first taper structure portion having both ends connected to the first lightwave propagation portion and to the first lightwave discontinuous portion, respectively and decreasing in light-receiving width as it goes from the first lightwave propagation portion to the first lightwave discontinuous portion, a second lightwave propagation portion having third light-receiving width, a second lightwave discontinuous portion having fourth light-receiving width, and a second taper structure portion having both ends connected to the second lightwave propagation portion and to the second lightwave discontinuous portion, respectively and decreasing in light-receiving width as it goes from the second lightwave propagation portion to the second lightwave discontinuous portion.

### CROSS-REFERENCE TO RELATED APPLICATIONS

This US non-provisional patent application claims priority under 35 USC §119 to Korean Patent Application No. 10-2011-0134353, filed on Dec. 14, 2011, the entirety of which is hereby incorporated by reference.

### BACKGROUND OF THE INVENTION

The present general inventive concept relates to cores and optical waveguides and, more particularly, to a core and an optical waveguide which reduce optic splice loss.

In order for lightwaves to propagate in a constrained state by total internal reflection principle, without radiating to the outside, there is required a structure in which a specific dielectric substance is surrounded by another dielectric substance with a relatively low refractive index. A lightwave propagation path in which the structure is maintained can be referred to as an optical waveguide, and an optical fiber for communication is a representative example to which the optical waveguide is applied. In an optical waveguide, a dielectric substance with a relatively high refractive index is called a core, and a dielectric substance with a relatively low refractive index surrounding the core substance is called a clad.

An optical waveguide may be implemented by applying an existing semiconductor process technology to an upper portion of a single-crystalline substrate. Optical elements manufactured in this way are generally called planar optical waveguide elements. Various optical circuits for performing different functions may be monolithically integrated on the same substrate. This monolithic integration makes it possible to reduce optical power loss which occurs during a process of optically connecting a plurality of optical waveguide elements configured as separate optical circuits. In general, to reduce optical power loss, there should be no discontinuous optical waveguide before a planar optical waveguide is connected to an optical fiber. However, a discontinuous optical waveguide inevitably exists on a substrate when there is a need to integrate an optical device such as a polarization rotator that has difficulty in being implemented only using an optical waveguide. Optical power loss increases at the discontinuous portion.

### SUMMARY OF THE INVENTION

Embodiments of the inventive concept provide a core and an optical waveguide.

An aspect of the inventive concept is directed to a core which may include a first waveguide propagation portion having first light-receiving width; a first lightwave discontinuous portion having second light-receiving width smaller than the first light-receiving width; a first taper structure portion having one end connected to the first lightwave propagation portion and the other end connected to the first lightwave discontinuous portion and decreasing in light-receiving width as it goes from the first lightwave propagation portion to the first lightwave discontinuous portion; a second lightwave propagation portion having third light-receiving width; a second lightwave discontinuous portion having fourth light-receiving width smaller than the third light-receiving width and the first light-receiving width; and a second taper structure portion having one end connected to the second lightwave propagation portion and the other end connected to the second lightwave discontinuous portion and decreasing in light-receiving width as it goes from the second lightwave propagation portion to the second lightwave discontinuous portion.

In an example embodiment, the first light-receiving width may be equal to the third light-receiving width, and the second light-receiving width may be equal to the forth light-receiving width.

In an example embodiment, the taper structure portion may decrease in light-receiving width at a constant rate from the first lightwave propagation portion to the first lightwave discontinuous portion. The second taper structure portion may decrease in light-receiving width at a constant rate from the second lightwave propagation portion and the second lightwave discontinuous portion.

In an example embodiment, the first taper structure portion decreases in light-receiving width from the first lightwave propagation portion to the first lightwave discontinuous portion in a multi-stage or parabolic form. The second taper structure portion decreases in light-receiving width from the second lightwave propagation portion to the second lightwave discontinuous portion in a multi-stage or parabolic form.

In an example embodiment, the core may further include a half-wavelength polarizer between the first lightwave discontinuous portion and the second lightwave discontinuous portion.

In an example embodiment, the half-wavelength polarizer may convert impinging transverse electric (TE) polarization to transverse magnetic (TM) polarization.

In an example embodiment, the half-wavelength polarizer may be made of a polymeric material such as polyimide or polyethylene naphthalate.

In an example embodiment, the first lightwave propagation portion, the first lightwave discontinuous portion, the first taper structure portion, the second lightwave propagation portion, the second lightwave discontinuous portion, and the second taper structure portion may be formed by applying a semiconductor process technology on a silica (SiO2) glass substrate, a polymer substrate or a single-crystalline substrate such as gallium arsenide (GaAs), indium phosphide (InP), and lithium niobate (LiNbO₃).

Another aspect of the inventive concept is directed to an optical waveguide which may include a lower clad formed on a substrate and having a first refractive index; a core formed on the lower clad and having a second refractive index; and an upper clad formed on the core and the lower clad and having the first refractive index. The core may include a first waveguide propagation portion having first light-receiving width; a first lightwave discontinuous portion having second light-receiving width smaller than the first light-receiving width; a first taper structure portion having one end connected to the first lightwave propagation portion and the other end connected to the first lightwave discontinuous portion and decreasing in light-receiving width as it goes from the first lightwave propagation portion to the first lightwave discontinuous portion; a second lightwave propagation portion having third light-receiving width; a second lightwave discontinuous portion having fourth light-receiving width smaller than the third light-receiving width and the first light-receiving width; and a second taper structure portion having one end connected to the second lightwave propagation portion and the other end connected to the second lightwave discontinuous portion and decreasing in light-receiving width as it goes from the second lightwave propagation portion to the second lightwave discontinuous portion.

In an example embodiment, the first refractive index is smaller than the second refractive index.

In an example embodiment, the substrate may be a silica (SiO2) glass substrate, a polymer substrate or a single-crystalline substrate such as gallium arsenide (GaAs), indium phosphide (InP), and lithium niobate (LiNbO₃). The first lightwave propagation portion, the first lightwave discontinuous portion, the first taper structure portion, the second lightwave propagation portion, the second lightwave discontinuous portion, and the second taper structure portion may be formed by applying a semiconductor process technology on the substrate.

### BRIEF DESCRIPTION OF THE DRAWINGS

The inventive concept will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the inventive concept.

FIG. 1 illustrates a typical core.

FIG. 2 is a graphic diagram illustrating optical power loss depending on discontinuous width.

FIG. 3 illustrates a core according to an embodiment of the inventive concept.

FIG. 4 illustrates a core according to another embodiment of the inventive concept.

FIG. 5 is a graphic diagram illustrating optical power loss depending on light-receiving width of first and second lightwave discontinuous portions included in a core according to an embodiment of the inventive concept.

FIG. 6 illustrates a core according to another embodiment of the inventive concept.

FIG. 7 illustrates a core according to another embodiment of the inventive concept.

FIG. 8 illustrates an optical waveguide according to an embodiment of the inventive concept.

FIG. 9 illustrates an optical waveguide according to another embodiment of the inventive concept.

### DETAILED DESCRIPTION

The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose examples of the inventive concept and to let those skilled in the art understand the nature of the inventive concept.

Reference is made to FIG. 1, which illustrates a typical core 10. The typical core 10 includes a half-wavelength polarizer 13 at a discontinuous portion. Widths 11 and 12 of the core 10 are W₁ and W₂, respectively, which are constant. A groove is formed in a length direction of the core 10, i.e., a direction perpendicular to an optical axis direction. And the half-wavelength polarizer 13 is included in the groove. However, the groove results in optical power loss.

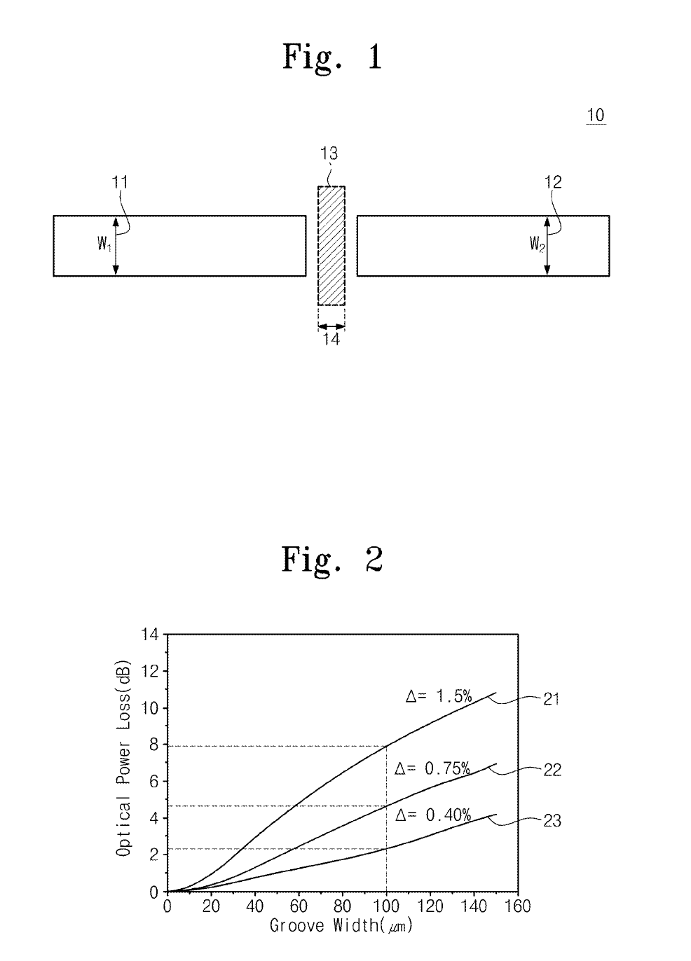

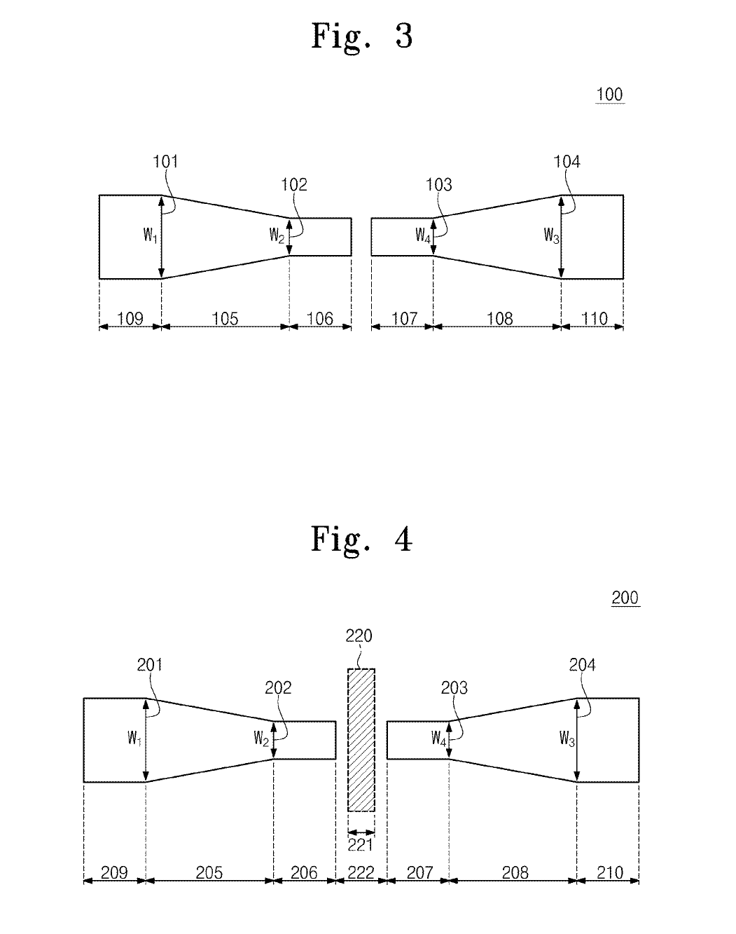

Reference is made to FIG. 2, which is a graphic diagram illustrating optical power loss depending on discontinuous width existing in the core 10 in FIG. 1.

FIG. 2 shows results obtained by calculating optical power loss depending on increase in width of a groove parallel to an optical axis in the core 10 in FIG. 1 through a beam propagation method (BPM). For the convenience, it was assumed that in the calculation through the BPM, a refractive index of the half-wavelength polarizer 13 is equal to that of a clad surrounding the core 10. The calculation results shown in FIG. 2 are obtained from three types of optical waveguides which have three different Δ of 1.5% (21), 0.75% (22), and 0.40% (23) while cores 10 have the same height of 6 μm. In the graph in FIG. 2, Δ represents a parameter that satisfies the equation (1) below.

Δ(%)=(n₁−n₀)/n₁×100 Equation (1)

In the equation (1), n₁ represents a refractive index of the core 10 and represents a refractive index of upper and lower dads.

As can be seen from the graph in FIG. 2, optical power loss increases as width of a groove increases and the parameter Δ increases. This is because the magnitude of beam of a lightwave radiated from the end of a left portion of the core 10 in FIG. 1 increases in a free space to reduce the amount of a lightwave received to the right end of the core 10. That is, it could be understood that when there is a discontinuous portion in a core, width of a groove and thickness 14 of the half-wavelength polarizer 13 are minimized to efficiently minimize the optical power loss. The most typical material for the half-wavelength polarizer 13 is single-crystalline quartz, and minimum thickness of single-crystalline quartz for rotating polarization of a lightwave with 1550 nm is about 90 μm. Groove width suitable for smoothly inserting the polarization with thickness of 90 μm into the groove in FIG. 1 is about 100 μm. As can be seen in FIG. 2, when the groove width is 100 μm and Δ are 1.5% (21), 0.75% (22), 0.40% (23), calculated values of optical power loss were 7.9 dB, 4.7 dB, and 2.8 dB, respectively. In the case that a polymer half-wavelength polarizer is used to reduce the optical power loss, additional optical power loss may decrease below 1.0 dB even when the parameter Δ is 1.5% that is great. Unfortunately, an additional technology is required to manufacture a polymer polarizer and the cost of the polymer polarizer is higher than that of a single-crystalline quartz polarizer.

Reference is made to FIG. 3, which illustrates a core 100 according to an embodiment of the inventive concept. The core 100 includes a first lightwave propagation portion 109, a first taper structure portion 105, a first lightwave discontinuous part 106, a second lightwave propagation portion 110, a second taper structure portion 108, and a second lightwave discontinuous portion 107.

The first lightwave propagation portion 109 is a portion where a lightwave propagates in a constrained state by total internal reflection without radiating to the outside. The first lightwave propagation portion 109 occupies most of the core 100. The first lightwave propagation portion 109 has a first light-receiving width (W1) 101. One end of the first lightwave propagation portion 109 is connected to one end of the first taper structure portion 105.

Similar to the first lightwave propagation portion 109, the first lightwave discontinuous portion 106 is a portion where a lightwave propagates in a constrained state by total internal reflection without radiating to the outside. The first lightwave discontinuous portion 106 has second light-receiving width (W₂) 102. One end of the first lightwave discontinuous portion 106 is connected to one end of the first taper structure portion 105 that is not connected to the first lightwave propagation portion 109, and the other end of the first lightwave discontinuous portion 106 corresponds to a discontinuous portion of the core 100.

Similar to the first lightwave propagation portion 109 and the first lightwave discontinuous portion 106, the first taper structure portion 105 is a portion where a lightwave propagates in a constrained state by total internal reflection without radiating to the outside. One end of the first lightwave propagation portion 109 and one end of the first lightwave discontinuous portion 106 are connected to both ends of the first taper structure portion 105, respectively. Accordingly, light-receiving width of one end connected to the first lightwave propagation portion 109 is the first light-receiving width (W₁) 101 and light-receiving width of the other end connected to the first lightwave discontinuous portion 106 is the second light-receiving width (W₂) 102. The first taper structure portion 105 decreases in light-receiving width as it goes from the first lightwave propagation portion 109 to the first lightwave discontinuous portion 106. From the first lightwave propagation portion 109 to the first lightwave discontinuous portion 106, the light-receiving width of the first taper structure portion 105 may decrease at a constant rate.

The second lightwave propagation portion 110 is a portion where a lightwave propagates in a constrained state by total internal reflection without radiating to the outside. The second lightwave propagation portion 110 occupies most of the core 100. The second lightwave propagation portion 110 has third light-receiving width (W₃) 104. One end of the second lightwave propagation portion 110 is connected to one end of the second taper structure portion 108.

Similar to the second lightwave propagation portion 110, the second lightwave discontinuous portion 107 is a portion where a lightwave propagates in a constrained state by total internal reflection without radiating to the outside. The second lightwave discontinuous portion 107 has fourth light-receiving width (W₄) 103. One end of the second lightwave discontinuous portion 107 is connected to one end of the second taper structure portion 108 that is not connected to the second lightwave propagation portion 110, and the other end of the second lightwave discontinuous portion 107 corresponds to a discontinuous portion of the core 100.

Similar to the second lightwave propagation portion 110 and the second lightwave discontinuous portion 107, the second taper structure portion 108 is a portion where a lightwave propagates in a constrained state by total internal reflection without radiating to the outside. One end of the second lightwave propagation portion 110 and one end of the second lightwave discontinuous portion 107 are connected to both ends of the second taper structure portion 108, respectively. Accordingly, light-receiving width of one end connected to the second lightwave propagation is the third light-receiving width (W3) 104 and light-receiving width of the other end connected to the second lightwave discontinuous portion 107 is the fourth light-receiving width (W₄) 103. The second taper structure portion 108 decreases in light-receiving width as it goes from the second lightwave propagation portion 110 to the second lightwave discontinuous portion 107. From the second lightwave propagation portion 110 to the second lightwave discontinuous portion 107, the light-receiving width of the second taper structure portion 108 may decrease at a constant rate.

Of the core 100 according to an embodiment of the inventive concept, the first light-receiving width (W₁) 101 may be equal to the third light-receiving width (W3) 104, and the second light-receiving width (W₂) 102 may be equal to the fourth light-receiving width (W₄) 103.

The core 100 according to an embodiment of the inventive concept may reduce optical power loss of a discontinuous portion that inevitably occurs when there is a need to integrate optical elements. Since the light-receiving width (W₂) 102 of one end of the first taper structure portion 102 having the same light-receiving width as the second light-receiving width (W₂) 102 that is the light-receiving width of the first lightwave discontinuous portion 106 is less than the first light-receiving width (W₁) 101 of the first lightwave propagation portion 109, constraint of a lightwave mode is gradually reduced. For this reason, a radiation angle of a lightwave radiated from one end of the first lightwave discontinuous portion 106 corresponding to a discontinuous portion is reduced. And, if the second light-receiving width (W₂) 102 does not decrease far below a specific value where there is no waveguide mode, optical power loss of the discontinuous portion is efficiently reduced.

Reference is made to FIG. 4, which illustrates a core 200 according to another embodiment of the inventive concept. The core 200 includes a first lightwave propagation portion 209, a first taper structure portion 205, a first lightwave discontinuous portion 206, a second lightwave propagation portion 210, a second taper structure portion 208, a second lightwave discontinuous portion 207, and a half-wavelength polarizer 220. The first lightwave propagation portion 209, the first taper structure portion 205, the first lightwave discontinuous portion 206, the second lightwave propagation portion 210, the second taper structure portion 208, and the second lightwave discontinuous portion 207 in FIG. 4 are identical to the corresponding elements in FIG. 3 and will not be explained in further detail.

The half-wavelength polarizer 220 is disposed between the first lightwave discontinuous portion 206 and the second lightwave discontinuous portion 207. The half-wavelength polarizer 220 transfers transverse electric (TE) polarization impinging from the first lightwave discontinuous portion 206 to the second lightwave discontinuous portion 207 after converting the TE polarization to transverse magnetic (TM) polarization.

Unlike the core 100 in FIG. 3, the core 200 in FIG. 4 further includes the half-wavelength polarizer 220 at a discontinuous portion. The core 200 further including half-wavelength polarizer 220 may be used in a polarization rotator.

The half-wavelength polarizer 220 may be made of a polymeric material such as polyimide or polyethylene naphthalate. Since a half-wavelength polarizer made of a polymeric material such as polyimide or polyethylene naphthalate has much smaller thickness (221) than single-crystalline quartz that is a typical material, discontinuous portion or groove width (222) may be relatively reduced. As a result, optical power loss is further reduced.

The first lightwave propagation portions 109 and 209, the first lightwave discontinuous portions 106 and 206, the first taper structure portions 105 and 205, the second lightwave propagation portions 110 and 210, the second lightwave discontinuous portions 107 and 207, and the second taper structure portions 108 and 208 included in the cores 100 and 200 in FIGS. 3 and 4 may be formed by applying a semiconductor process technology on a silica (SiO2) glass substrate, a polymer substrate or a single-crystalline substrate such as gallium arsenide (GaAs), indium phosphide (InP), and lithium niobate (LiNbO₃). When they are formed by applying a semiconductor process technology, various types of optical circuits may be integrated on the same substrate to further reduce optical power loss.

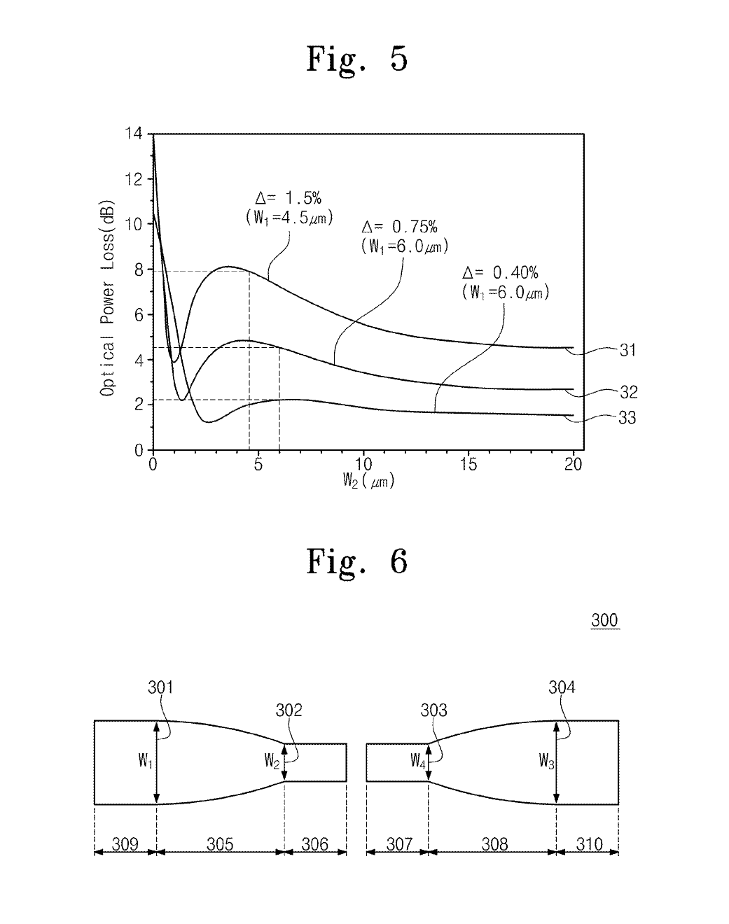

Reference is made to FIG. 5, which is a graphic diagram illustrating optical power loss depending on light-receiving width of the first and second lightwave discontinuous portions 206 and 207 included in the core 200 in FIG. 4. FIG. 5 shows results obtained by calculating optical power loss, which occurs when light-receiving widths W2 and W4 of the first and second lightwave discontinuous portions 206 and 207 change from 0 μm to 20 μm, through a beam propagation method (BPM).

For the convenience, it was assumed that in the calculation through the BPM, a refractive index of the half-wavelength polarizer 220 is equal to that of a clad (not shown) surrounding the core 200, and length of the first and second taper structure portions 205 and 208 and length of the first and second lightwave discontinuous portions 206 and 207 were fixed to 2000 μm and 500 μm, respectively. The calculation results shown in FIG. 5 are obtained from three types of optical waveguides where the parameters Δ in the equation (1) are 1.5%, 0.75%, and 0.40%, respectively. In the three kinds of optical waveguides, light-receiving widths W₁ and W₃ of the first and second lightwave propagation portions 209 and 210 are 4.5 μm and 6.0 μm, respectively while the core 200 has the same heights h₁ of 6 μm.

As can be seen from the graph in FIG. 5, there is a region where optical power loss is smallest when light-receiving widths W₂ and W₄ of the first and second lightwave discontinuous portions 206 and 207 are less than the light-receiving widths W₁ and W₃ of the first and second lightwave propagation portions 209 and 210. This is because constraint of a waveguide mode is gradually reduced as the light-receiving widths W₂ and W₄ of the first and second lightwave discontinuous portions 206 and 207 decrease. In other words, this is because a radiation angle of a lightwave radiated to one end of the first lightwave discontinuous portion 206 decreases but there is no waveguide mode when the light-receiving width W₂ of the first lightwave discontinuous portion 206 is reduced below a specific value. As a result, optical power loss may be reduced using the core 200 according to an embodiment of the inventive concept when there is a discontinuous portion in a core.

Reference is made to FIG. 6, which illustrates a core 300 according to another embodiment of the inventive concept. The core 300 includes a first lightwave propagation portion 309, a first taper structure portion 305, a first lightwave discontinuous portion 306, a second lightwave propagation portion 310, a second taper structure portion 308, and a second lightwave discontinuous portion 307. The first lightwave propagation portion 309, the first lightwave discontinuous portion 306, the second lightwave propagation portion 310, and the second lightwave discontinuous portion 307 in FIG. 6 are identical to the corresponding elements in FIG. 3 and will not be explained in further detail.

Similar to the first taper structure portion 105 and the second taper structure portion 108 in FIG. 3, the first taper structure portion 305 and the second taper structure portion 308 are portions where a lightwave propagates in a constrained state by total internal reflection without radiating to the outside. The first taper structure portion 305 in FIG. 6 decreases in light-receiving width as it goes from the first lightwave propagation portion 309 to the first lightwave discontinuous portion 306, and the second taper structure 308 in FIG. 6 decreases in light receiving width as it goes from the second lightwave propagation portion 310 to the second lightwave discontinuous portion 307. Unlike the first and second taper structure portion 105 and 108 in FIG. 3, the first and second taper structure portions 305 and 308 in FIG. 6 decreases not linearly but parabolically from the first and second lightwave propagation portions 309 and 310 to the first and second lightwave discontinuous portions 306 and 307. In case of the parabolic tapering, the first and second taper structure portions 305 and 308 may be designed to have short lengths, as compared to linear tapering.

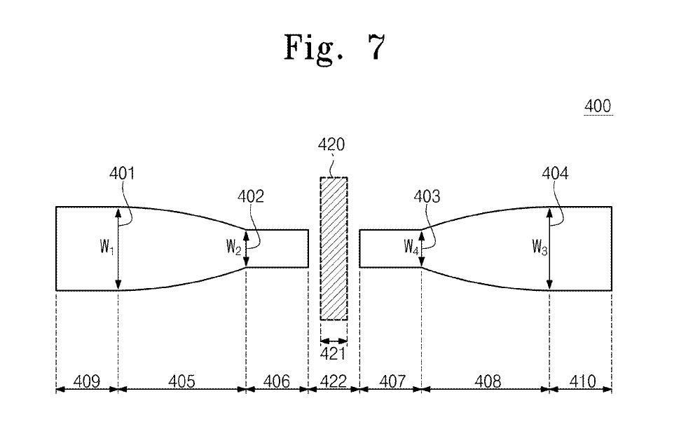

Reference is made to FIG. 7, which illustrates a core 400 according to another embodiment of the inventive concept. The core 400 includes a first lightwave propagation portion 409, a first taper structure portion 405, a first lightwave discontinuous portion 406, a second lightwave propagation portion 410, a second taper structure portion 408, a second lightwave discontinuous portion 407, and a half-wavelength polarizer 420. The first lightwave propagation portion 409, the first taper structure portion 405, the first lightwave discontinuous portion 406, the second lightwave propagation portion 410, the second taper structure portion 408, and the second lightwave discontinuous portion 407 in FIG. 7 are identical to the corresponding elements in FIG. 6 and will not be explained in further detail.

The half-wavelength polarizer 420 is disposed between the first lightwave discontinuous portion 406 and the second lightwave discontinuous portion 407. The half-wavelength polarizer 420 transfers transverse electric (TE) polarization impinging from the first lightwave discontinuous portion 406 to the second lightwave discontinuous portion 407 after converting the TE polarization to transverse magnetic (TM) polarization.

Unlike the core 300 in FIG. 6, the core 400 in FIG. 7 further includes the half-wavelength polarizer 420 at a discontinuous portion. The core 400 further including half-wavelength polarizer 420 may be used in a polarization rotator.

The half-wavelength polarizer 420 may be made of a polymeric material such as polyimide or polyethylene naphthalate. Since a half-wavelength polarizer made of a polymeric material such as polyimide or polyethylene naphthalate has much smaller thickness (421) than single-crystalline quartz that is a typical material, discontinuous portion or groove width (422) of the half-wavelength polarizer may be relatively reduced. As a result, optical power loss is further reduced.

A first lightwave propagation portion, a first lightwave discontinuous portion, a first taper structure portion, a second lightwave propagation portion, a second lightwave discontinuous portion, and a second taper structure portion included in the above-described cores 100, 200, 300 or 400 may be formed by applying a semiconductor process technology on a silica (SiO2) glass substrate, a polymer substrate or a single-crystalline substrate such as gallium arsenide (GaAs), indium phosphide (InP), and lithium niobate (LiNbO₃).

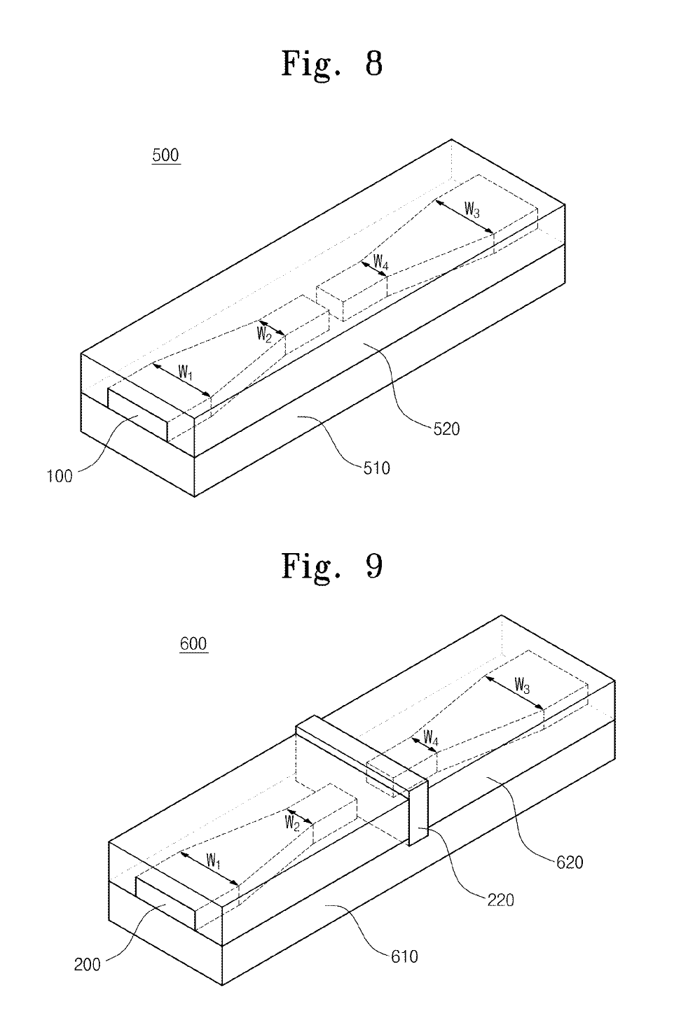

Reference is made to FIG. 8, which illustrates an optical waveguide 500 according to an embodiment of the inventive concept. The optical waveguide 500 includes a core 100 including a discontinuous portion described in FIG. 3, a lower clad 510, and an upper clad 520. The core 100 included in the optical waveguide 500 is identical to that described in FIG. 3 and will not be described in further detail.

The lower clad 510 and the upper clad 520 are dielectric materials with a first refractive index. The lower clad 510 is formed on a substrate, and the core 100 that is another dielectric material with a second refractive index is formed on the lower clad 510. The upper clad 520 may be formed on the lower clad 510 and the core 100 to surround the core 100 together with the lower clad 510.

Since the second refractive index of the core 100 is greater than that of the lower and upper clads 510 and 520, a lightwave propagates in a constrained state by total internal reflection without radiating to the outside.

Reference is made to FIG. 9, which illustrates an optical waveguide 600 according to another embodiment of the inventive concept. The optical waveguide 600 includes a core 200 including a discontinuous portion described in FIG. 4, a lower clad 610, and an upper clad 620. The core 200 included in the optical waveguide 600 is identical to the core 200 described in FIG. 4, and the lower clad 610 and the upper clad 620 are identical to the lower clad 510 and the upper clad 520 described in FIG. 8, respectively. Therefore, the core 200, the lower clad 610, and the upper clad 620 will not be described in further detail. Unlike the optical waveguide 500 in FIG. 8, the optical waveguide 600 in FIG. 9 further includes a half-wavelength polarizer 220 to be used to implement a polarization rotator.

According to a core and an optical waveguide described so far, optic splice loss between discontinuous optical waveguides existing on the same substrate is reduced.

While the inventive concept has been particularly shown and described with reference to exemplary embodiments thereof, it will be apparent to those of ordinary skill in the art that various changes in form and detail may be made therein without departing from the spirit and scope of the inventive concept as defined by the following claims.

What is claimed is:

1. A core comprising:
a first waveguide propagation portion having first light-receiving width;
a first lightwave discontinuous portion having second light-receiving width smaller than the first light-receiving width;
a first taper structure portion having one end connected to the first lightwave propagation portion and the other end connected to the first lightwave discontinuous portion and decreasing in light-receiving width as it goes from the first lightwave propagation portion to the first lightwave discontinuous portion;
a second lightwave propagation portion having third light-receiving width;
a second lightwave discontinuous portion having fourth light-receiving width smaller than the third light-receiving width and the first light-receiving width; and
a second taper structure portion having one end connected to the second lightwave propagation portion and the other end connected to the second lightwave discontinuous portion and decreasing in light-receiving width as it goes from the second lightwave propagation portion to the second lightwave discontinuous portion.

2. The core of claim 1, wherein the first light-receiving width is equal to the third light-receiving width and the second light-receiving width is equal to the forth light-receiving width.

3. The core of claim 1, wherein the first taper structure portion decreases in light-receiving width at a constant rate from the first lightwave propagation portion to the first lightwave discontinuous portion and
wherein the second taper structure portion decreases in light-receiving width at a constant rate from the second lightwave propagation portion and the second lightwave discontinuous portion.

4. The core of claim 1, wherein the first taper structure portion decreases in light-receiving width from the first lightwave propagation portion to the first lightwave discontinuous portion in a multi-stage or parabolic form, and
wherein the second taper structure portion decreases in light-receiving width from the second lightwave propagation portion to the second lightwave discontinuous portion in a multi-stage or parabolic form.

5. The core of claim 1, further comprising:
a half-wavelength polarizer between the first lightwave discontinuous portion and the second lightwave discontinuous portion.

6. The core of claim 5, wherein the half-wavelength polarizer is made of a polymeric material such as polyimide or polyethylene naphthalate.

7. The core of claim 1, wherein the first lightwave propagation portion, the first lightwave discontinuous portion, the first taper structure portion, the second lightwave propagation portion, the second lightwave discontinuous portion, and the second taper structure portion are formed by applying a semiconductor process technology on a silica (SiO2) glass substrate, a polymer substrate or a single-crystalline substrate such as gallium arsenide (GaAs), indium phosphide (InP), and lithium niobate (LiNbO₃).

8. An optical waveguide comprising:
a lower clad formed on a substrate and having a first refractive index;
a core formed on the lower clad and having a second refractive index; and
an upper clad formed on the core and the lower clad and having the first refractive index,
wherein the core comprises:
a first waveguide propagation portion having first light-receiving width;
a first lightwave discontinuous portion having second light-receiving width smaller than the first light-receiving width;
a first taper structure portion having one end connected to the first lightwave propagation portion and the other end connected to the first lightwave discontinuous portion and decreasing in light-receiving width as it goes from the first lightwave propagation portion to the first lightwave discontinuous portion;
a second lightwave propagation portion having third light-receiving width;
a second lightwave discontinuous portion having fourth light-receiving width smaller than the third light-receiving width and the first light-receiving width; and
a second taper structure portion having one end connected to the second lightwave propagation portion and the other end connected to the second lightwave discontinuous portion and decreasing in light-receiving width as it goes from the second lightwave propagation portion to the second lightwave discontinuous portion.

9. The optical waveguide of claim 9, wherein the first refractive index is smaller than the second refractive index.

10. The optical waveguide of claim 8, wherein the first light-receiving width is equal to the third light-receiving width and the second light-receiving width is equal to the forth light-receiving width.

11. The optical waveguide of claim 8, wherein the first taper structure portion decreases in light-receiving width at a constant rate from the first lightwave propagation portion to the first lightwave discontinuous portion and
wherein the second taper structure portion decreases in light-receiving width at a constant rate from the second lightwave propagation portion to the second lightwave discontinuous portion.

12. The optical waveguide of claim 8, wherein the first taper structure portion decreases in light-receiving width from the first lightwave propagation portion to the first lightwave discontinuous portion in a multi-stage or parabolic form, and
wherein the second taper structure portion decreases in light-receiving width from the second lightwave propagation portion to the second lightwave discontinuous portion in a multi-stage or parabolic form.

13. The optical waveguide of claim 8, further comprising:
a half-wavelength polarizer between the first lightwave discontinuous portion and the second lightwave discontinuous portion.

14. The optical waveguide of claim 13, wherein the half-wavelength polarizer is made of a polymeric material such as polyimide or polyethylene naphthalate.

15. The optical waveguide of claim 8, wherein the substrate is a silica (SiO2) glass substrate, a polymer substrate or a single-crystalline substrate such as gallium arsenide (GaAs), indium phosphide (InP), and lithium niobate (LiNbO₃) and
wherein the first lightwave propagation portion, the first lightwave discontinuous portion, the first taper structure portion, the second lightwave propagation portion, the second lightwave discontinuous portion, and the second taper structure portion are formed by applying a semiconductor process technology on the substrate.
